(19) United States
(12) Patent Application Publication
(10) Pub. No.: US 2017/0350460 A1
(43) Pub. Date: Dec. 7, 2017

(54) Brake Caliper

(71) Applicant: Ford Global Technologies, LLC, Dearborn, MI (US)

(72) Inventors: Philipp Meise, Köln (DE); Dirk Schaefer, Engelskirchen (DE)

(73) Assignee: Ford Global Technologies, LLC, Dearborn, MI (US)

(21) Appl. No.: 15/614,011

(22) Filed: Jun. 5, 2017

(30) Foreign Application Priority Data
Jun. 6, 2016 (DE) DE102016209863.2

(51) Int. Cl. F16D 55/2265; F16D 65/00

(52) U.S. Cl. CPC F16D 55/22655; F16D 65/0087; F16D 65/0068; F16D 2200/0056

(57) ABSTRACT

A brake caliper, for example a floating caliper, with a caliper housing and a guide element. The guide element fixed on one side to the caliper housing and moveably supported at a free end in a guide bushing. The guide bushing having a return mechanism that deflects with and returns the guide element to an initial position. The return mechanism also automatically adjusts when the guide element exceeds a predetermined amount of deflection.

### CROSS-REFERENCE TO RELATED APPLICATIONS

Not Applicable.

### BACKGROUND OF THE INVENTION

1. Field of the Invention

The present invention relates generally to a brake caliper; and more specifically, to a caliper having a linear guide and a guide element or bushing.

2. Description of Related Art

Vehicle brakes use brake calipers, sometimes called floating calipers. A floating or sliding caliper typically includes brake pads arranged on both sides of a brake disc; with a brake piston arranged behind one of the brake pads while the brake pad spaced from the brake piston is secured on the floating caliper. The brake piston is generally on the opposite side of the floating caliper from the wheel, owing to the small installation space available, and generally acts on the inner brake pad. The floating caliper is movably mounted in the axial direction of the brake disc; i.e. in a floating manner. Upon pressurizing the brake piston, the floating caliper aligns itself, with the linear guide, wherein both brake pads press on the brake disc with the same force. The linear guide fixed or anchored on one side in the floating caliper, wherein an opposite, free end of the linear guide passes through a caliper lug and is supported in an axially movable manner in a guide element or bushing. It is also possible for the free end of the linear guide to be movable in a guide element or bushing of the anchor, wherein the linear guide is fixed on the caliper lug.

Once the braking process ends, the brake piston interacts with a piston seal to retract a corresponding brake pad, typically the inner brake pad, positioning the inner pad in its rest position a distance from the brake disc. In contrast, the brake disc moves the opposite brake pad, typically the outer brake pad, to its rest position. Lateral runout of the brake disc produces a gap between the outer brake pad and the effective surface of the brake disc. However, this gives rise to unwanted retardation of the vehicle since the brake pads are in contact with the brake disc outside the desired braking process. Because this is performed in the same way on all four wheels it produces high resistance counter to the direction of travel giving rise to a high counter torque. The counter torque must be overcome by the engine correspondingly increasing fuel consumption. This effect is also observed with possible faults in the brake disc/brake pad system.

Increased fuel consumption is not the only disadvantage. Due to impact and friction of the brake disc wear of the outer brake pad is greater than on the inner brake pad, causing early stage brake pad replacement. In principle, a pair of brake pads, the inner and outer brake pad, should be replaced together, even though the inner brake pad might not need replacement. Also, noise resulting from random impact of the brake disc on the brake pad may lead occupants of the vehicle to suspect a fault in the brake system. Squealing noises can also arise, possibly leading the occupants to conclude that the vehicle is of low quality.

### SUMMARY OF THE INVENTION

A brake caliper having a guide element and a guide bushing. The guide bushing having a plurality of inwardly extending triangular-shaped tooth members arranged in a sawtooth configuration, each tooth having a tooth root connected to an inner circumference of the guide bushing and a tooth tip, each tooth tip engaging the guide element.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a brake caliper according to an exemplary embodiment of the invention.

FIG. 2 is a perspective view of a guide element of the brake caliper of FIG. 1.

FIG. 3 is a cross-sectional schematic view of a guide bushing of the brake caliper of FIG. 1 in a rest position.

FIG. 4 is a cross-sectional schematic view of a guide bushing of the brake caliper, showing the guide bushing of FIG. 3 in a use position.

FIG. 5 is a cross-sectional schematic view of a guide bushing of the brake caliper, showing the guide bushing of FIG. 3 in an operational situation resulting from brake wear.

FIG. 6 is a cross-sectional schematic view of an alternative embodiment of a guide bushing of the brake caliper of FIG. 1 in a rest position.

FIG. 7 is a cross-sectional schematic view of a guide bushing of the brake caliper of FIG. 6 in a use position.

### DETAILED DESCRIPTION OF THE PREFERRED EMBODIMENTS

The following description of the preferred embodiment(s) is merely exemplary in nature and is in no way intended to limit the invention, its application, or uses.

In the various figures, identical parts are always provided with the same reference sign, for which reason they also generally described only once.

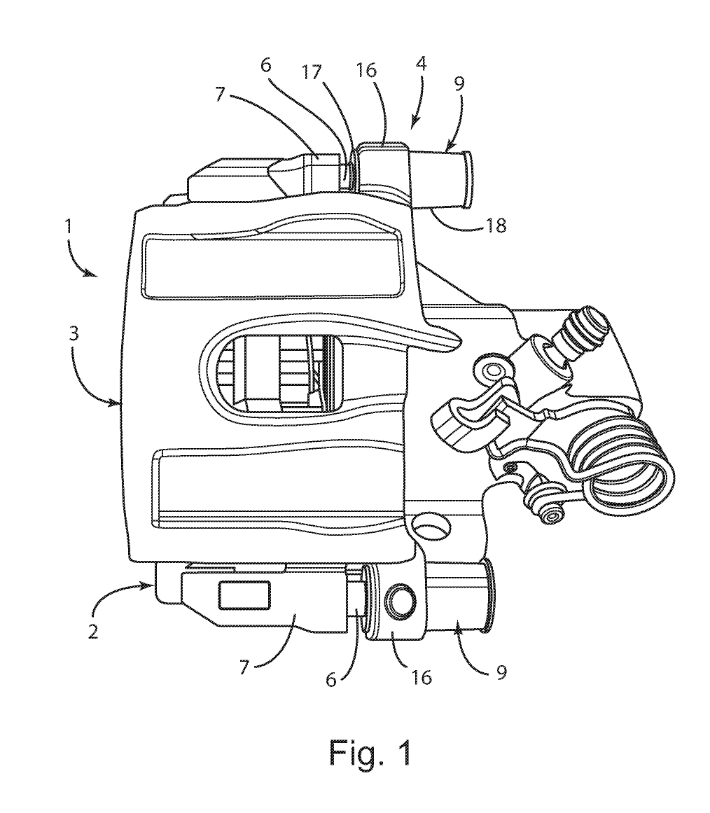

FIG. 1 is an exemplary embodiment of a brake caliper, illustrated as a floating caliper 1. The floating caliper 1 includes a caliper housing 3, and a linear guide, seen generally at 4. Brake pads (not visible) are held on the floating caliper. An inner brake pad is arranged on a side of the floating caliper on the right in the plane of the drawing. A brake piston (not visible) acts directly on the inner brake pad. The other brake pad, i.e. the outer brake pad, is guided movably on the caliper housing 3.

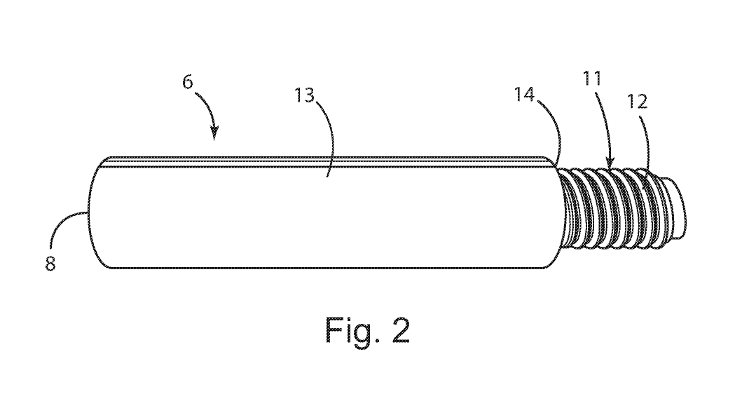

The linear guide 4 has a guide element 6 fixed in a receptacle 7 of an anchor plate or bracket 2. The free end 8, see FIG. 2, of the guide element 6 is linearly movable in a guide bushing 9 of the caliper housing 3. FIG. 1 illustrates that the floating caliper 1 has two guide elements 6, each arranged laterally with respect to the anchor plate or bracket 2, and in a respective receptacle 7 of the anchor plate or bracket 2 and the respective guide bushing 9.

The guide element 6, also called a guide pin, has a threaded section 12 on a fastening end 11. The threaded section 12 received in a corresponding thread within the receptacle 7 of the anchor plate or bracket 2 and fixing the guide element 6 on the anchor plate or bracket 2. A main body 13 adjoins the threaded section 12 and extends with an unchanging diameter to the free end 8. As illustrated, the main body 13 can be a cylindrical main body. The guide element 6 is preferably composed of a metal. The guide element 6 includes a stepped transition section or portion 14 between the threaded section 12 and the main body 13 forming an end face or abutment surface of the main body 13 facing the threaded section 12.

The guide element 6 projects beyond the receptacle 7 of the anchor 2 and its main body 13 passes through a lug 16 of the caliper housing 3, with the guide bushing 9 also in the lug 16.

The guide bushing 9 is open on one side and preferably closed with a plug on the other side. The opening oriented toward the anchor plate or bracket 2. The guide bushing 9 including a locating section 17 and an adjoining bearing section 18. The locating section 17 locates the guide bushing 9 in position in the lug 16. The bearing section 18 is in the lug 16 and extends away from the locating section 17 and the anchor plate or bracket 2.

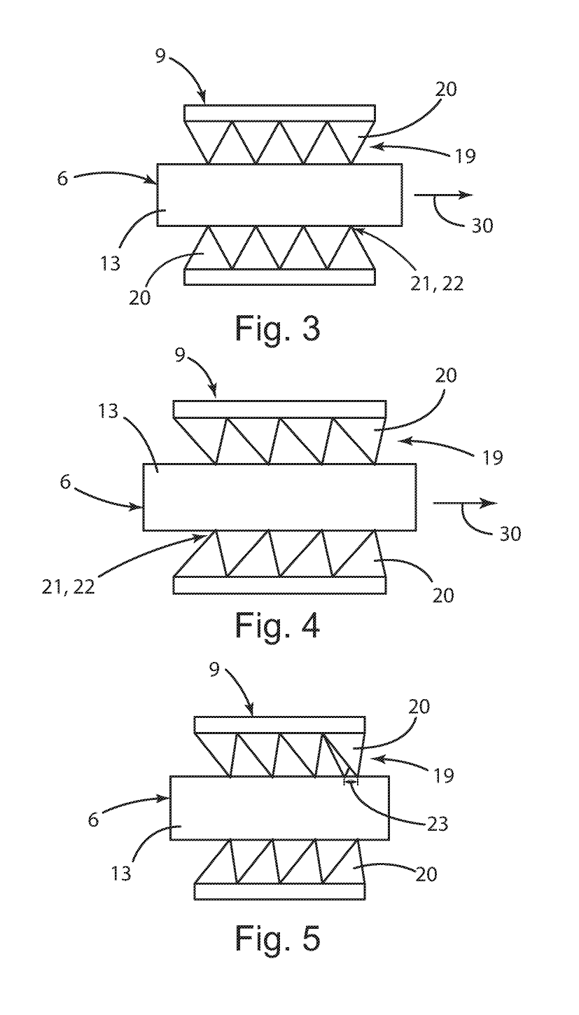

FIG. 3 illustrates an exemplary embodiment of a return mechanism 19. The return mechanism 19 includes the guide bushing 9 having a plurality of inwardly projecting deflectable, resilient members 20. FIG. 3 shows only a section of the main body 13. The inwardly projecting deflectable, resilient members 20 having a pin contact surface 22 engaging the main body 13 of the guide element 6. As shown, the inwardly projecting deflectable, resilient members 20 extend radially inward such that the pin contact surfaces 22 form an inside diameter smaller than an outside diameter of the main body 13 of the guide element 6. Accordingly, the pin contact surface 22 of the return mechanism 19 frictionally engages the surface of the main body 13 of the guide element 6. As shown in FIG. 4, when the guide element 6 deflects in the direction of the use position; i.e. moves to the right in the direction illustrated by the arrow 30, the frictionally engaged pin contact surface 22 deflects or moves in the direction of the use position.

As illustrated in FIGS. 3-5 the return mechanism 19 has a sawtooth configuration; that is a plurality of individual triangular-shaped teeth 20. Each tooth 20 has a tooth tip 21 forming at least a portion of the pin contact surface 22.

Each individual tooth 20 deflects with the movement of the guide element 6 whereby the return mechanism 19 stores a restoring force. The sawtooth configuration provides a simple setting of the desired characteristics of the return mechanism 19. The tooth height and width along with the stiffness of the material directly affect the effective restoring force and the distance established between the brake pad and the brake disc. Accordingly, the return mechanism 19 can produce different pulling forces and also be used to set brake pedal feel.

The brake pads are subject to operational wear, the friction surfaces of the brake pads and those of the brake disc wear down. The wear creates a gap between the brake complements, including between the outer brake pad and the brake disc. If the gap becomes too large the brake feel becomes spongy, something to avoid. The return mechanism 19 also adjusts or corrects for such a gap. For example, if the guide element 6 moves to its use position during a braking operation and the transfer path is too long, the friction coefficient established between the pin contact surface 22 and the surface of the guide element 6 is exceeded, because the tooth tip 21 forming the pin contact surface 22 may only deflect a predetermined distance in the direction 30. If the deflection is greater than the predetermined distance, the guide element 6 moves relative to the pin contact surfaces 22 of the return mechanism 19. Specifically, the guide element 6 slides in or along the return mechanism 19, wherein the teeth 20 initially deflect and then slide along the outer surface of the main body 13 back into their undeflected positions as illustrated by the double arrow 23 in FIG. 5. The guide element 6 moves relative to the guide bushing 9, resulting in a reset of entire system to an initial state. In this way, the return mechanism 19 compensates for wear and continuously acts on the guide element 6. Once adjusted, in future braking processes, the return mechanism 19 functions as shown in FIGS. 3 and 4.

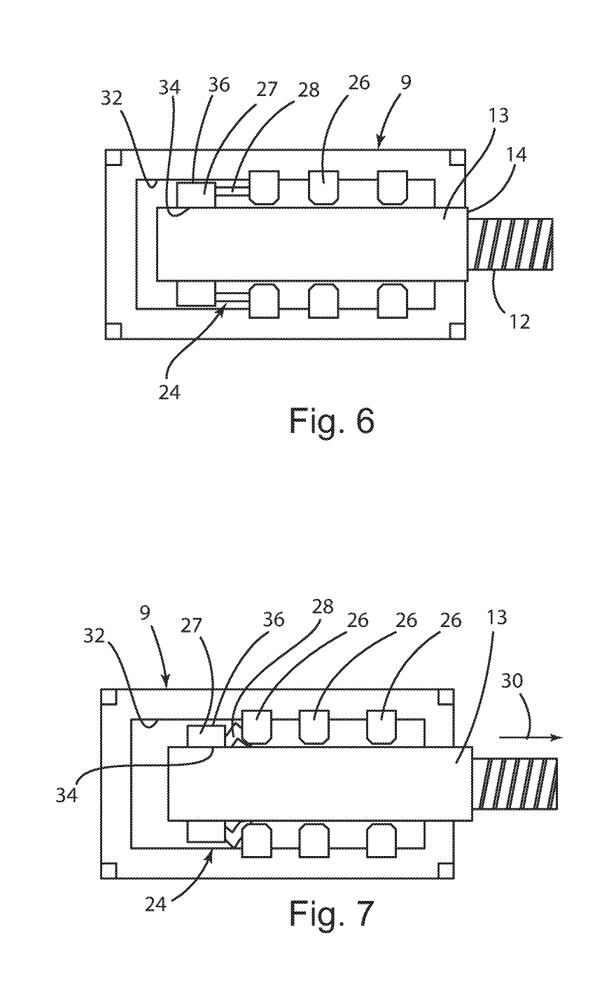

FIGS. 6 and 7 illustrate another embodiment of a return mechanism 24. The return device mechanism 24 includes the guide bushing 9 having a plurality of inwardly projecting rib-type raised portions 26 on its inner circumference. The free ends of the raised portions 26 contact the surface of the guide element 6, forming a sliding bearing. The rib-type configuration provides stability for the guide element 6, and centers the guide element 6 in the guide bushing 9.

The return mechanism 24 includes a ring 27, having an inside diameter smaller than the outside diameter of the guide element 6 causing frictional contact between the inner or contact surface 34 of the ring 27 and the outer surface of the guide element 6. By way of example, the surface 36 of the ring 27 opposite the guide element 6 is spaced a distance from the inner surface 32 of the guide bushing 9. The inner or contact surface 34 of the ring 27 does not contact the interior of the guide bushing 9. On a side arranged toward the threaded section 12 of the guide element 6, the ring 27 has a contact web 28, connected and supported on the nearest raised portion 26. The contact web 28 is of elastic design; i.e. a deflectable, resilient member.

The contact web 28 and ring 27 can be separate from the guide bushing 9, wherein the raised portions 26 can likewise be separate from the guide bushing 9. In such a case, the raised portions 26 are secured to the inner surface 32 of the guide bushing 9, by various methods including adhesively bonding, plastic welding, or other mechanisms. The contact web 28, ring 27, and raised portions 26 preferably over the full circumference or in a manner interrupted in the circumferential direction, on the surface of the guide element 6 to form a sliding bearing.

It is also possible for the ring 27 to be an insert separate from the guide bushing 9 and held in position in the guide bushing 9. The ring 27, contact web 28, raised portions 26, and the guide bushing 9 may also be an integral member.

When a braking process causes movement of guide element 6 relative to the guide bushing 9 in the direction of arrow 30, it compresses the contact web 28 as shown in FIG. 7. Once the braking process ends, web 28 exerts a force, stored in the contact web 28, to return the guide element 6 to the initial position thereof, i.e. to the rest position thereof.

The ring 27 slides along the guide element 6 to readjust for brake pad wear, implementing a readjustment function as set forth above. The ring 27 designed to be in frictional engagement with the surface of the main body 13 through inner surface 34 whereby, despite its preferably contactless configuration with respect to the inner surface 32 of the guide bushing 9, sliding along the outer surface of the main body 13 of the guide element 6 occurs upon introduction of a predetermined or defined force. For example, the predetermined or defined force upon compressing the contact web 28 results in the ring 27 sliding along the guide element. In one embodiment, the position of an adjacent raised portion 26 cooperates with the contact web 28 to slide the ring 27 on the outer surface of the guide element 6.

FIGS. 6 and 7 illustrate only schematically a guide bushing 9 wherein separate illustration of the locating section and of the bearing section has been dispensed with.

In the illustrative embodiment shown in FIGS. 6 and 7, the return mechanism 24, i.e. the ring 27, contact web 28, and the raised portions 26, our shown arranged on an inner side of the guide bushing 9. In this way, the distance between the ring 27 and the free end 8 of the guide element 6 will ensure that the readjustment, i.e. compensating function, is available. It is also possible to arrange the return mechanism 24 with the ring 27 and contact web 28 situated opposite thereto, on an outer side, or in between.

The brake caliper includes an anchor plate or bracket 2, a caliper housing 3, and a linear guide 4 having a guide element 6, fixed on one side 11 and supported movably at its free end 8 in a guide bushing 9. The guide bushing 9 including a return mechanism 19 returning the guide element 6 from a use position to a rest position after a braking process.

In an exemplary embodiment, the brake caliper 1 is a floating caliper. During a braking process, the linear guide 4 aligns the floating caliper to press both brake pads on the brake disc with the same force. After the braking process, both brake pads are, moved back from the brake disc. The brake piston acts on one brake pad while the return mechanism 19 acts other brake pad. In the exemplary embodiment, the brake piston acts on the inner brake pad and the return mechanism 19 acts on the outer brake pad.

The guide element 6 is also called a guide pin. The guide element 6 has on its fastening end 11 a threaded section 12 that mates with a corresponding thread within a receptacle of the anchor plate or bracket 2 fixing the guide element 6 on the anchor plate or bracket 2. The guide element 6 includes a main body 13, having an unchanging diameter extending to the free end 8, adjacent the threaded section 12. The main body 13 in one example is a cylindrical body. The main body 13 may taper or thicken toward the free end 8, with the change taking place continuously or in a stepped manner. The guide element 6 is preferably composed of metal. A stepped transition 14 between the threaded section 12 and the main body 13 creates an end face or abutment surface facing the threaded section 12 between the main body 13 and the threaded section 12. The step transition 14, that is the end face or abutment surface, locates the guide element 6 in the receptacle; that is, it prevents for example screwing the guide element too far into the receptacle.

The free end 8 of the guide element 6 protrudes from the receptacle of the anchor plate 2 with the main body 13 of the guide element 6 passing through a lug 16 of the caliper housing 3. The guide bushing 9 engages the lug 16. As illustrated, the guide bushing 9 is open on one side. The opening faces toward the anchor plate 2. The guide bushing 9 has a locating section and an adjoining bearing section. The locating section, securely locates the guide bushing 9 in position in the lug 16. The bearing section extends away from the lug 16 and the anchor plate or bracket 2.

As disclosed, in the exemplary embodiment, the return mechanism 19, 24 includes a spring-elastic element. Initially, the brake pressure moves the guide element 6 from a rest position, in a direction 30, to a use position and stresses the spring-elastic element whereby it stores the absorbed force. Initially, the spring-elastic element does not move relative to the guide element 6 but moves with the guide element 6. Upon reducing the brake pressure, i.e. after the braking process, the stored or absorbed force in the spring-elastic element, returns the guide element 6 to the rest position and correspondingly moves the outer brake pad, not subjected to a load by the brake piston, to its rest position. The spring-elastic element pulls or draws the guide element 6 back to its initial position.

Stressing of the return mechanism 19, i.e. loading of the spring-elastic element, may be brought about by providing the return mechanism 19 with a pin contact surface 22 having an inside diameter smaller than an outside diameter of the main body 13 of the guide element 6. The smaller diameter creates a frictional engagement between the pin contact surface 22 and the surface of the guide element 6, wherein the pin contact surface 22 moves with or deflects when guide element 6 moves in the direction 30 of the use position. The return mechanism 19 may be a solid body extending into an annular space between the inner circumference of the guide bushing and the outer circumference of the guide element. It is also possible for the mechanism 19 to be interrupted along its longitudinal axis. In one embodiment, pin contact surface 22 continuously contacts the corresponding surface of the guide element 6 when viewed in the circumferential direction.

FIGS. 3-5 illustrate the return mechanism 19 having a plurality of inwardly extending triangular shaped tooth members 20 shown in a sawtooth configuration, wherein the tooth tips 21 form the pin contact surface 22. The tooth roots opposite to the tooth tips 21 directly connect to inner circumference of the guide bushing 9. Each individual tooth 20 deflects with movement of the guide element 6 and stores the restoring force. The sawtooth configuration provides one embodiment of the desired characteristics of the return mechanism 19. Thus, the tooth height, tooth width and the stiffness or resiliency the tooth material directly effect on the effective restoring force of the spring-elastic element and the distance to be established between the brake pad and the brake disc, producing different pulling forces and setting brake pedal feel.

The guide bushing 9, and the return mechanism 19 may comprise a plastic, a rubber material, a terpolymer elastomer (EPDM), or other resilient materials capable of storing energy.

The guide bushing 9 can advantageously be embodied integrally with the return mechanism 19. The elastic properties of the pin contact surface 22 may differ from those of an external shell of the guide bushing 9. The return mechanism 19 can extend over the entire length of the guide bushing 9 and, with its pin contact surface 22, surround the surface of the guide element 6, preferably over the entire circumference. The return mechanism 19 may also be arranged only in the locating section, the bearing section, or in other regions of the guide bushing 9. In the exemplary embodiment, the return mechanism 19 is in the bearing section of the guide bushing.

The return mechanism 19, 24 may also be a separate insert positioned in the guide bushing 9, wherein an outer circumference of the insert can be connected or secured to, to the inner circumference of the guide bushing. Adhesive joints are preferable but other types of joint, e.g. joints involving plastics welding techniques or frictional joints, are also conceivable. If a separate insert is provided, it is likewise possible for the material properties of the guide bushing 9 and insert to be set independently, wherein different properties in stiffness and elasticity are also possible. The return mechanism 19, 24 can be formed separately from the guide bushing 9, with an outer circumference of the return mechanism 19 spaced apart from the inner surface of the guide bushing 9. Despite the contactless embodiment with respect to the inner circumference of the guide bushing 9, return of the guide element 6 would nevertheless be possible on completion of the braking process, as would wear compensation.

Uniform wear of the brake pads is achieved since the brake pad not acted upon by a brake piston is also moved away from the brake disc and held a distance therefrom by the return mechanism 19, 24. Pushing back of the brake pad by the brake disc causing nonuniform wear can be avoided. The otherwise usual random impact of the brake disc on the brake pad is also avoided since the brake pad is held in the desired position, i.e. at the desired distance from the brake disc.

During use the brake pads are subject to operational wear, and therefore the friction surfaces of the brake pads are worn down, as are those of the brake disc. If the gap between the brake pads, i.e. between the outer brake pad and the brake disc, becomes too large the brake feel becomes spongy, something that should be avoided. The return mechanism 19, 24 simultaneously adjusts or corrects four brake pad or brake disk wear. If the guide element 6 is moved into its use position during a braking operation and if this transfer path is so long that the friction coefficient established between the pin contact surface 22 and the surface of the guide element is exceeded, it produces movement of the guide element 6 relative to the guide bushing 9. In this movement, the guide element 6 slides along the mechanism 19, 24, wherein the latter simultaneously slides back into its initial position, resetting the entire system to the initial state. In this way, the functionality according to the invention is reestablished, with simultaneous compensation for the wear.

Because, in one exemplary embodiment, the return mechanism 19 has the sawtooth configuration, the teeth 20 initially deflect and return or slide back to the undeflected position, with the guide element 6 moved initially relative to the guide bushing 9 and with the entire system being reset, to the initial state, upon release of or terminating the braking process. In this way, the wear simultaneously having been compensated.

In another embodiment, the return device 24 includes a ring 27 having a contact web 28 connected thereto. Raised portions 26 are arranged on an inner circumference of the guide bushing 9. The contact web 28 extends in the direction of a directly adjacent raised portion 26. In one alternative embodiment, the contact web 28 extends in a straight line from the ring 27 to the raised portion 26. The contact web 28 can be formed both on the raised portion 26 and on the ring 27. It is also possible for the contact web 28 to be separate from the ring 27 and formed on the raised portion 26 or for the contact web 28 to be separate from the raised portion 26 and formed on the ring 27. The return mechanism 24 arranged close to the free end 8 of the guide element 6 in the interior of the guide bushing 9. During a braking process, the contact web 28 compresses to generate a restoring force. When the braking process ends, the restoring force moves the guide element 6 to its initial position. As with the previous embodiment, the return mechanism 24 includes a readjustment function or feature wherein when wear on the brake pad and/or the brake disc is too great; the ring 27 slides on the outer surface of the guide element 6 compensating for the wear.

Although the invention has been described in such a way that the guide element 6, also called a guide pin, is screwed into the anchor plate or bracket 2 and is movable relative to the caliper housing 3, it is also possible to connect the guide element 6 securely to the caliper housing 3 with the free end movably mounted in a guide bushing of the anchor. In this way, the return mechanism 19, 24 could assume centering functions within the guide bushing in addition to the adjusting or correcting function, simultaneously with the return of the guide element and of the brake pad to the rest position thereof.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A brake caliper comprising:
a guide element;
a guide bushing, said guide bushing having a plurality of inwardly extending triangular-shaped tooth members arranged in a sawtooth configuration, each tooth having a tooth root connected to an inner circumference of the guide bushing and a tooth tip, each tooth tip engaging said guide element.

2. The brake caliper of claim 1 wherein said plurality of inwardly extending triangular-shaped tooth members are formed of a resilient material.

3. The brake caliper of claim 1 wherein each tooth tip includes first and second tooth sides meeting at a vertex, wherein only one of said first and second sides engages said guide element.

4. The brake caliper of claim 1 each tooth tip includes first and second two sides meeting at a vertex, wherein when said tooth tip engages said guide element, both of said first and second sides engage said guide element.

5. The brake caliper of claim 1 wherein the triangular-shaped tooth members are formed of an elastomeric material.

6. A brake caliper comprising:
a guide element;
a guide bushing, said guide bushing having body, a ring and a web extending between said ring and said guide bushing, said ring contacting said guide element.

7. The brake caliper of claim 6 wherein said web is formed of a resilient material.

8. The brake caliper of 7 including a plurality of inwardly projecting raised portions on an inner circumference of said guide bushing.

9. The brake caliper of claim 8 wherein each inwardly projecting raised portion includes a free end, said free end contacting a surface of the guide element.

10. The brake caliper of claim 6 wherein the web is formed of an elastomeric material.

11. A brake caliper comprising:
a floating caliper;
an anchor;
a caliper housing;
a linear guide including a guide element, said guide element fixed on one side and supported movably at a free end in a guide bushing, said guide bushing including a return mechanism having a plurality of inwardly projecting triangular-shaped members, each triangular-shaped projecting member defining a pin contact surface, said pin contact surface having an inside diameter smaller than an outside diameter of the guide element.

12. The brake caliper of claim 11 wherein each triangular-shaped projecting member is a spring-elastic element.

13. The brake caliper of claim 11 wherein the triangular-shaped projecting members are arranged in a sawtooth configuration, each triangle-shaped projecting member having a tooth tip, said tooth tips forming said pin contact surface.

14. The brake caliper of claim 11 wherein said tooth tips frictionally engage said guide element.

15. The brake caliper of claim 11 wherein said inwardly projecting triangular-shaped members are formed of an elastomeric material.
